(19) United States
(12) Patent Application Publication
(10) Pub. No.: US 2026/0079364 A1
(43) Pub. Date: Mar. 19, 2026

(54) DISPLAY DEVICE

(71) Applicant: Japan Display Inc., Tokyo (JP)

(72) Inventors: Yoshio MARUOKA, Tokyo (JP); Kentaro OKUYAMA, Tokyo (JP); Koji KITAMURA, Tokyo (JP)

(73) Assignee: Japan Display Inc., Tokyo (JP)

(21) Appl. No.: 19/326,838

(22) Filed: Sep. 12, 2025

(30) Foreign Application Priority Data
Sep. 18, 2024 (JP) 2024-161190

(51) Int. Cl. G02F 1/1333; G02F 1/13357

(52) U.S. Cl. CPC G02F 1/133382; G02F 1/133615

(57) ABSTRACT

A display device includes a heater line containing metal, a first substrate including a first line, a second substrate facing the first substrate, and a liquid crystal layer provided between the first substrate and the second substrate, and the heater line is provided so as to overlap with a position of the first line and extend along the first line in plan view.

### CROSS-REFERENCE TO RELATED APPLICATION

The present application claims priority to Japanese Patent Application No. 2024-161190 filed on Sep. 18, 2024, the disclosure of which is incorporated herein by reference.

### TECHNICAL FIELD

This disclosure relates to a display device.

### BACKGROUND

Patent Document 1 (Japanese Unexamined Patent Application Publication No. 2006-47455) discloses a liquid crystal display device for vehicle, which includes a liquid crystal panel and a transparent planar heater having a transparent conductive film for heating formed on one surface of a transparent planar substrate. Patent Document 2 (Japanese Unexamined Patent Application Publication No. 2023-167697) discloses a display device including an array substrate having a display region in which pixels are arranged and a peripheral region located outside the display region.

### SUMMARY

However, there is a problem in that the performance of the display device deteriorates due to the decrease in the falling response speed of liquid crystal caused as the ambient temperature becomes lower. Therefore, an object is to improve the performance of the display device.

Other objects and novel features will become apparent from the descriptions of this specification and accompanying drawings.

A semiconductor device according to one embodiment includes a heater line containing metal, a first substrate including a first line, a second substrate facing the first substrate, and a liquid crystal layer provided between the first substrate and the second substrate, and the heater line is provided so as to overlap with a position of the first line and extend along the first line in plan view.

### BRIEF DESCRIPTION OF DRAWINGS

FIG. 1 is an explanatory diagram illustrating a positional relationship when a viewer on one side of a transparent display panel visually recognizes a background on an opposite side of the panel through the transparent display panel.

FIG. 2 is an explanatory diagram illustrating an example of the background visually recognized through the transparent display panel.

FIG. 3 is a perspective view illustrating an example of a display device.

FIG. 4 is a cross-sectional view of the display device illustrated in FIG. 3.

FIG. 5 is an overhead view of the display device illustrated in FIG. 4.

FIG. 6 is a circuit block diagram illustrating an example of a circuit provided in the display device illustrated in FIG. 4.

FIG. 7 is a cross-sectional view of a display device according to another embodiment.

FIG. 8 is an overhead view of the display device illustrated in FIG. 7.

FIG. 9 is a cross-sectional view of a display device according to another embodiment.

FIG. 10 is an overhead view of the display device illustrated in FIG. 9.

FIG. 11 is a cross-sectional view of a display device according to another embodiment.

FIG. 12 is an overhead view of the display device illustrated in FIG. 11.

FIG. 13 is a cross-sectional view of a display device according to another embodiment.

FIG. 14 is an overhead view of the display device illustrated in FIG. 13.

FIG. 15 is a cross-sectional view of a display device according to another embodiment.

FIG. 16 is an overhead view of the display device illustrated in FIG. 15.

FIG. 17 is a cross-sectional view of a display device according to another embodiment.

FIG. 18 is an overhead view of the display device illustrated in FIG. 17.

### DETAILED DESCRIPTION OF THE INVENTION

Hereinafter, each embodiment of the present invention will be described with reference to drawings. Note that the disclosure is merely an example, and it is a matter of course that any alteration that is easily made by a person skilled in the art while keeping a gist of the present invention is included in the range of the present invention. In addition, the drawings schematically illustrate a width, a thickness, a shape, and the like of each portion as compared with actual aspects in order to make the description clearer, but the drawings are merely examples and do not limit the interpretation of the present invention. Further, the same elements as those described in relation to the foregoing drawings are denoted by the same reference characters in this specification and the respective drawings, and detailed descriptions thereof will be omitted as appropriate.

In this application, the embodiment will be described in a plurality of separated sections or the like if necessary as a matter of convenience. However, unless otherwise specified, these are not mutually independent and irrelevant, but are respective parts of a single example regardless of the order of description, or one is a partial detail or a partial or overall modification of the other. Also, repetitive description of similar parts will be omitted in principle. Furthermore, each component in the embodiment is not necessarily indispensable, unless otherwise specified, when it is theoretically limited to that number, or when it is clearly indispensable from the context.

In addition, in the accompanying drawings, hatching or the like may be omitted even in cross sections if such hatching would unnecessarily complicate the drawings or if voids can be clearly distinguished without it. In relation to this, when it is clear from the description or the like, the background contour lines may be omitted even for the holes that are closed in plan view. Furthermore, even if the drawing is not a cross section, hatching or dot patterns may be applied in order to clearly indicate that it is not a void or to clearly indicate the boundary of regions.

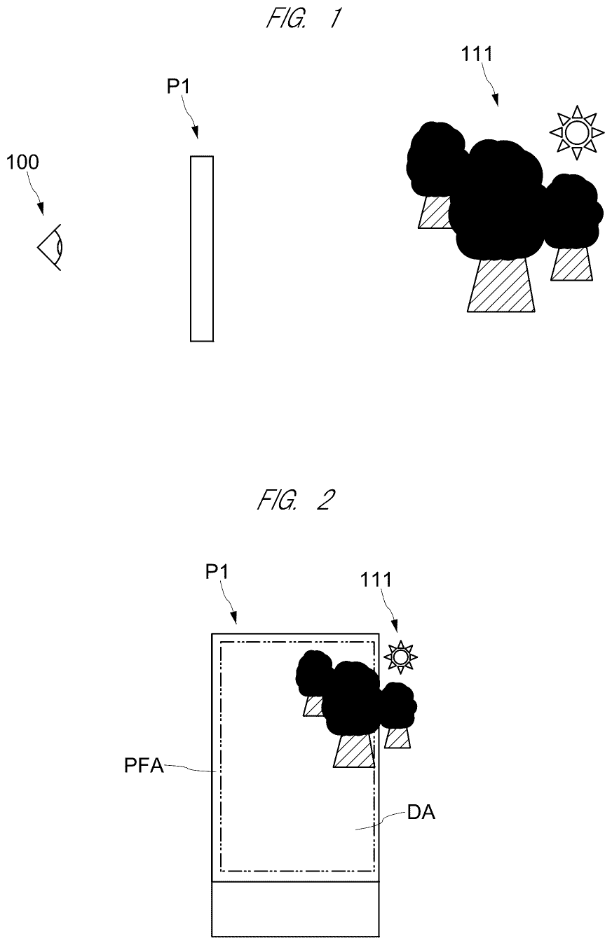

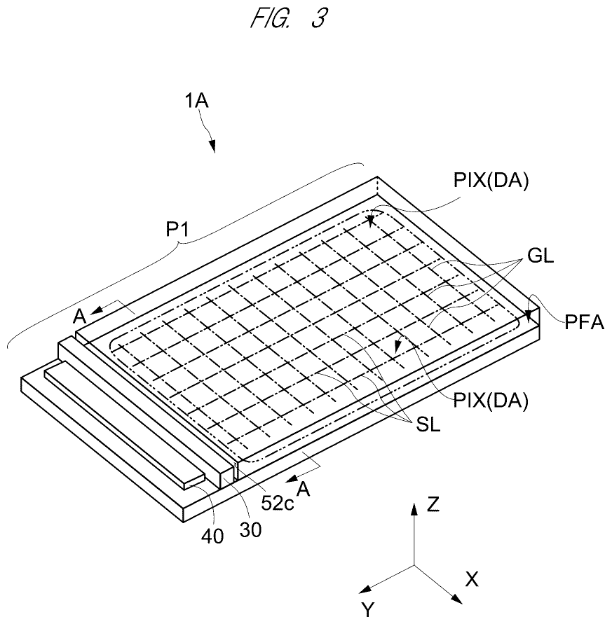

A display device according to this embodiment will be described. The display device according to this embodiment includes a transparent display panel. First, features of the transparent display panel will be described. FIG. 1 is an explanatory diagram illustrating a positional relationship when a viewer on one side of a transparent display panel visually recognizes a background on an opposite side of the panel through the transparent display panel. FIG. 2 is an explanatory diagram illustrating an example of the background visually recognized through the transparent display panel.

As illustrated in FIG. 1, when an observer 100 views the other side of a display panel P1 from one side thereof, a background 111 is visually recognized through the display panel P1. As illustrated in FIG. 2, when a display region DA (PIX) and a peripheral region PFA located outside the display region DA both allow light to pass through, the entire background 111 can be visually recognized without sense of visual discomfort. On the other hand, when the peripheral region PFA has light blocking properties and does not allow light to pass through, a part of the background 111 visually recognized through the display panel P1 is blocked by the peripheral region PFA, which may cause the observer 100 to experience the sense of visual discomfort. As described above, in the case of the display panel P1 which is a transparent display panel, each of the display region DA and the peripheral region PFA preferably has visible light transmittance. Also, from the viewpoint of visually recognizing the background 111 without sense of visual discomfort, it is particularly preferable that each of the display region DA and the peripheral region PFA has approximately the same visible light transmittance.

FIG. 3 is a perspective view illustrating an example of a display device. In FIG. 3, a boundary between the display region DA and the peripheral region PFA is indicated by a double-dot-dash line. Also, in FIG. 3, a part of signal lines (that is, gate line GL and source line SL) for transmitting signals to drive liquid crystal in the circuit provided in the display panel P1 is schematically indicated by dot-dash lines. In the following drawings including FIG. 3, the direction along the thickness direction of the display panel P1 will be described as the Z direction, and in the X-Y plane perpendicular to the Z direction, the extending direction of one side of the display panel P1 will be described as the X direction and the direction intersecting with the X direction will be described as the Y direction.

As illustrated in FIG. 3, a display device 1A according to this embodiment includes the display panel P1, a light source unit 30, and a drive circuit 40.

When configured as a display device, it may include, for example, a flexible substrate connected to the display panel P1 or a housing in some cases in addition to the respective components provided in the display panel P1 illustrated in FIG. 3. In FIG. 3, illustration of components other than the display panel P1 is omitted. Also, the display device 1A according to this embodiment does not have to include a polarization plate.

The display panel P1 has the display region DA in which images are formed in accordance with input signals supplied from outside and the peripheral region (frame region) PFA located around the display region DA. Although the display region DA of the display panel P1 illustrated in FIG. 3 is quadrangle, the display region DA may have the shape other than quadrangle such as polygon or circle. The display region DA is an effective region in which the display panel P1 displays images in plan view showing a display surface. In FIG. 3, the display surface is parallel to the X-Y plane. In the example illustrated in FIG. 3, the light source unit 30 and the drive circuit 40 are each mounted on the display panel P1. As a modification, however, a light source substrate (not illustrated) may be provided in addition to the display panel P1 in the peripheral region PFA of the display panel P1, and the light source unit 30 may be mounted on the light source substrate (not illustrated).

### <Display Panel>

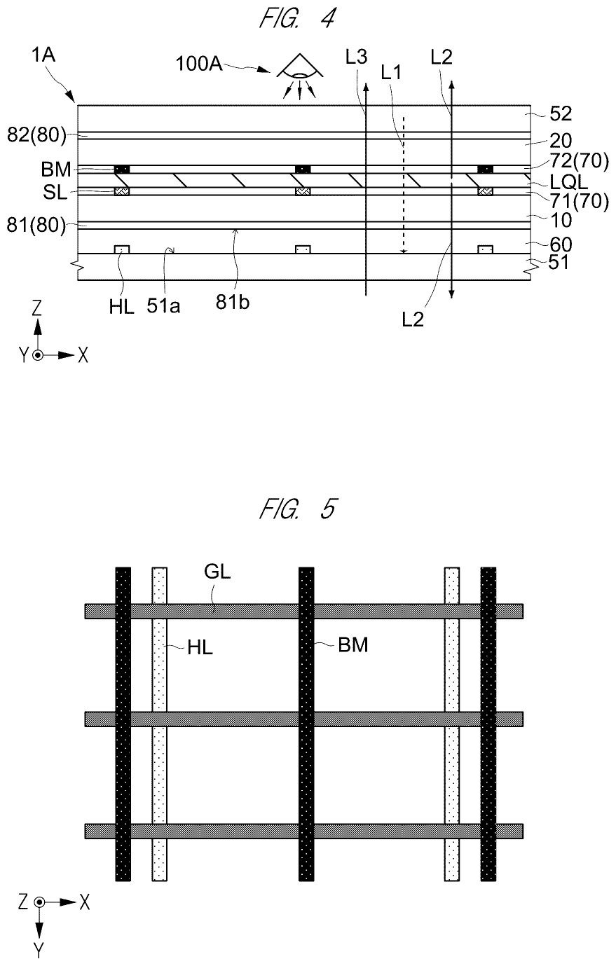

The configuration of the display panel P1 will be described. FIG. 4 is a cross-sectional view of the display device illustrated in FIG. 3. FIG. 4 is a cross-sectional view taken along the line A-A in FIG. 3. That is, FIG. 4 is a cross-sectional view illustrating the cross section taken by cutting the display panel of the display device illustrated in FIG. 3 by the plane perpendicular to the Y direction. Although FIG. 4 is a cross-sectional view, the hatching on the respective members other than a liquid crystal layer LQL is omitted. FIG. 5 is an overhead view of the display device illustrated in FIG. 4. FIG. 5 is an overhead view illustrating the display device illustrated in FIG. 4 viewed from above.

As illustrated in FIG. 4, the display panel P1 includes an array substrate 10, a counter substrate 20, a front cover substrate 52, a rear cover substrate 51, adhesive layers 80, the liquid crystal layer LQL, alignment films 70, a planarization layer 60, a heater line HL, a light blocking material BM, and a source line SL.

The array substrate 10 may simply be referred to as the substrate, but in the following description, it is referred to as the array substrate 10 in the sense that the substrate has a plurality of switching elements arranged in an array. As illustrated in FIG. 4, the array substrate 10 has an upper surface and a lower surface opposite to the upper surface. The upper surface of the array substrate 10 and the lower surface of the array substrate 10 are spaced apart from each other. The array substrate 10 further has a side surface provided between the upper surface and the lower surface. In this embodiment, the array substrate 10 is a TFT (Thin Film Transistor) substrate. As illustrated in FIG. 4 and FIG. 5, the array substrate 10 includes the source line SL and the gate line GL. As illustrated in FIG. 4, the source line SL is provided on the upper surface of the array substrate 10. The source line SL is in contact with the upper surface of the array substrate 10. The array substrate 10 has visible light transmittance. A switching element (active element) Tr which will be described later may be provided on the array substrate 10. The thickness of the array substrate 10 is, for example, between 0.1 mm and 10 mm. The source line SL illustrated in FIG. 4 is the line for transmitting video signals. The gate line GL illustrated in FIG. 5 is the line for transmitting scanning signals.

When the display panel P1 is seen in plan view, light L1 emitted from the light source unit 30 appears to travel in the Y direction. Also, when the X-Z plane is seen in plan view in FIG. 4, the light L1 emitted from the light source unit 30 appears to travel in the Z direction while repeating total reflection. As illustrated in FIG. 3, the source line SL is provided along the Y direction. That is, the source line SL is provided along the traveling direction of light emitted from the light source unit 30 when the display panel P1 is seen in plan view. Also, as illustrated in FIG. 5, the gate line GL is provided so as to intersect with the source line SL when the display panel P1 is seen in plan view. In this embodiment, the source line SL and the gate line GL are orthogonal to each other. The source line SL and the gate line GL are spaced apart from each other. The source line SL is electrically separated from the gate line GL. In the overhead view illustrated in FIG. 5, the source line SL is hidden behind the light blocking material BM. Here, the phrase “the display panel P1 is seen in plan view” refers to seeing the X-Y plane of FIG. 3 in plan view.

As illustrated in FIG. 4, the counter substrate 20 is spaced apart from the array substrate 10. The counter substrate 20 may simply be referred to as the substrate, but in the following description, it is referred to as the counter substrate 20 in the sense that it is disposed at the position facing the array substrate 10. The counter substrate 20 has an upper surface and a lower surface opposite to the upper surface. The upper surface of the counter substrate 20 and the lower surface of the counter substrate 20 are spaced apart from each other. The counter substrate 20 further has a side surface provided between the upper surface and the lower surface. As illustrated in FIG. 4, the lower surface of the counter substrate 20 and the upper surface of the array substrate 10 face each other. The counter substrate 20 has visible light transmittance. The thickness of the counter substrate 20 is, for example, between 0.1 mm and 10 mm.

The counter substrate 20 is bonded to the array substrate 10 via a sealing portion (sealing material) SLM. The sealing portion (sealing material) SLM adheres the array substrate 10 and the counter substrate 20. The sealing portion SLM adheres the upper surface of the array substrate 10 and the lower surface of the counter substrate 20. The sealing portion SLM is provided so as to surround the outer periphery of the liquid crystal layer LQL. The sealing portion SLM surrounds the entire liquid crystal layer LQL together with the array substrate 10 and the counter substrate 20. In other words, there is the liquid crystal layer LQL inside the sealing portion SLM. The sealing portion SLM functions as a seal for enclosing the liquid crystal layer LQL between the array substrate 10 and the counter substrate 20. In addition, the sealing portion SLM functions as an adhesive for adhering the array substrate 10 to the counter substrate 20.

As illustrated in FIG. 4, the liquid crystal layer LQL is provided between the upper surface of the array substrate 10 and the lower surface of the counter substrate 20. The liquid crystal layer LQL contains liquid crystal LQ. The liquid crystal layer LQL is an optical modulation element whose light transmission state can be changed by electrically driving the alignment state of liquid crystal molecules. The display panel P1 has a function to modulate the light L1 passing therethrough by changing the alignment state of the liquid crystal molecules by controlling the state of electric field formed around the liquid crystal layer LQL via the switching element described above.

The liquid crystal LQ is polymer-dispersed liquid crystal LC and includes a liquid crystalline polymer and liquid crystal molecules. The liquid crystalline polymer is formed in a fibrillar shape, and the liquid crystal molecules are dispersed in the gaps of the liquid crystalline polymer. Each of the liquid crystalline polymer and the liquid crystal molecules has optical anisotropy or refractive index anisotropy. The responsiveness of the liquid crystalline polymer to an electric field is lower than that of the liquid crystal molecules to an electric field. The alignment direction of the liquid crystalline polymer hardly changes regardless of the presence or absence of the electric field.

Meanwhile, the alignment direction of the liquid crystal molecules changes depending on the electric field in the state where a voltage higher than a threshold is applied to the liquid crystal LQ. In the state where no voltage is applied to the liquid crystal LQ, optical axes of the liquid crystalline polymer and the liquid crystal molecules are parallel to each other. Therefore, the light L1 entering the liquid crystal layer LQL is scarcely scattered in the liquid crystal layer LQL and passes therethrough (transparent state). In the state where a voltage is applied to the liquid crystal LQ, the optical axes of the liquid crystalline polymer and the liquid crystal molecules intersect with each other. Therefore, the light L1 entering the liquid crystal LQ is scattered in the liquid crystal layer LQL (scattering state). The display panel P1 controls the transparent state and the scattering state by controlling the alignment of the liquid crystal LQ in the propagation path of the light L1. In the scattering state, the light L1 is emitted as emission light L2 by the liquid crystal LQ to the outside of the display panel P1 from the upper surface side of the front cover substrate 52. Also, background light L3 entering from the lower surface side of the rear cover substrate 51 is emitted to the outside from the upper surface of the front cover substrate 52 after passing through the array substrate 10, the liquid crystal layer LQL, the counter substrate 20, the front cover substrate 52, and others. The emission light L2 and the background light L3 are visually recognized by the observer located on the upper surface side of the front cover substrate 52. The observer can recognize the emission light L2 and the background light L3 in combination. As described above, the transparent display panel P1 is the display panel P1 with which the observer can recognize the displayed image and the background overlapped with each other.

As illustrated in FIG. 4, an alignment film 71 is provided between the upper surface of the array substrate 10 and the liquid crystal layer LQL. The alignment film 71 can align the liquid crystal molecules of the liquid crystal LQ. The alignment film 71 is in contact with the liquid crystal LQ of the liquid crystal layer LQL.

The light blocking material BM is provided on the lower surface of the counter substrate 20. The light blocking material BM is provided along the source line SL. When the display panel P1 is seen in plan view, the position of the light blocking material BM overlaps with the position of the source line SL. When the display panel P1 is seen in plan view, the width of the light blocking material BM is preferably larger than that of the source line SL. When the display panel P1 is seen in plan view, the source line SL is preferably disposed in a region in which the light blocking material BM is located. The light blocking material BM is formed of, for example, a black-colored resin or a metal material. Examples of the metal material include copper, aluminum, chromium, molybdenum, titanium, Al alloy, and others.

As illustrated in FIG. 4, an alignment film 72 is provided between the lower surface of the counter substrate 20 and the liquid crystal layer LQL. The alignment film 72 can align the liquid crystal molecules of the liquid crystal LQ. The alignment film 72 is in contact with the liquid crystal LQ of the liquid crystal layer LQL. Hereinafter, the alignment film 71 and the alignment film 72 may be collectively referred to as the alignment film 70.

As illustrated in FIG. 4, the rear cover substrate 51 has an upper surface and a lower surface opposite to the upper surface. Each of the rear cover substrate 51 and the front cover substrate 52 described later may simply be referred to as the substrate, but in the following description, they are referred to as the rear cover substrate 51 and the front cover substrate 52 in order to distinguish them from each other. The upper surface and the lower surface are spaced apart from each other. Also, the rear cover substrate 51 further has a side surface provided between the upper surface and the lower surface. In this embodiment, the rear cover substrate 51 is made of glass. In other words, the rear cover substrate 51 is a glass substrate made of glass. The rear cover substrate 51 has visible light transmittance. Examples of the material of the rear cover substrate 51 include organic materials such as acrylic resin and polycarbonate resin in addition to glass. The thickness of the rear cover substrate 51 is, for example, between 0.5 mm to 10 mm.

As illustrated in FIG. 4, the heater line HL is provided on the upper surface 51a of the rear cover substrate 51. The heater line HL is in contact with the upper surface 51a of the rear cover substrate 51. The heater line HL contains metal. The heater line HL contains, for example, a single metal or an alloy. Examples of the single metal include copper and aluminum. Examples of the alloy include an Al alloy (aluminum alloy). The heater line HL may include not only a single layer but also multiple layers. The heater line HL includes, for example, a metal line and a coating layer that covers the outer surface of the metal line.

In this embodiment, the heater line HL is provided along the source line SL. When the display panel P1 is seen in plan view, the position of the heater line HL overlaps with the position of the source line SL. In the example illustrated in FIG. 4, the heater line HL is provided along the Y direction. In other words, when the display panel P1 is seen in plan view, the heater line HL is provided parallel to the light incident direction. Here, the light incident direction refers to the direction in which the light emitted from the light source unit enters the display panel P1 when the display panel P1 is seen in plan view. In the example illustrated in FIG. 4, the light incident direction refers to the direction in which the light emitted from the light source unit enters a side surface 52c of the front cover substrate 52 when the display panel P1 is seen in plan view. That is, in the example illustrated in FIG. 4, the light incident direction is the Y direction.

The heater line HL is a heater using a resistance heating method. In other words, the heater line HL can generate heat by allowing a current to pass through the heater line HL. When the display panel P1 is seen in plan view, the width of the heater line HL is, for example, between 0.05 μm and 10 μm. In order to increase the heating capacity of the heater line HL, the resistance of the heater line is reduced to increase the current flowing through the heater line HL. For this purpose, the thickness of the heater line HL is preferably between 1 μm and 5 μm. It is preferable to make the thickness of the heater line HL large within this thickness range because the resistance of the heater line HL is lowered. This is because this makes it possible to increase the current flowing through the heater line HL even at the same applied voltage. On the other hand, if the thickness of the heater line HL is large, the light emitted from the light source unit 30 and entering the panel P1 is scattered by the heater line HL, resulting in the deterioration in contrast. For this reason, from the viewpoint of preventing scattered light, the thickness of the heater line HL is more preferably between 0.1 μm and 1 μm, and even more preferably between 0.3 μm and 0.7 μm. This makes the light emitted from the light source unit 30 less likely to be scattered by the heater line HL.

In the example illustrated in FIG. 4, three source lines SL are provided, and three heater lines HL are provided along the respective source lines SL. On the other hand, as another embodiment, for example, only two heater lines HL may be arranged for three source lines SL. In other words, the number of heater lines HL may be made smaller than the number of source lines SL. In addition, when the display panel P1 is seen in plan view, it is preferable that the plurality of heater lines HL is arranged at equal intervals. This makes the moire less noticeable even if it occurs due to the viewing angle.

The planarization layer 60 is provided on the upper surface 51a of the rear cover substrate 51. The planarization layer 60 is provided so as to cover the heater lines HL. The planarization layer 60 has an upper surface and a lower surface opposite to the upper surface. The lower surface of the planarization layer 60 is in contact with the rear cover substrate 51. Since the planarization layer 60 covers the heater lines HL, the upper surface of the planarization layer 60 and the heater lines HL are spaced apart from each other. In other words, the thickness of the planarization layer 60 is larger than the thickness of the heater lines HL. This makes it possible to protect the heater lines HL. Therefore, it is possible to prevent the heater lines HL containing metal from corroding with, for example, an adhesive layer 81. Furthermore, when the heater line HL is provided on the upper surface 51a of the rear cover substrate 51, a step is formed. The step can be reduced by providing the planarization layer 60 so as to cover the heater line HL. This makes it easier to attach the rear cover substrate 51 on which the heater line HL is provided to another substrate. The thickness of the planarization layer 60 is preferably 1 to 10 times the thickness of the heater line HL, and more preferably 1.5 to 5 times. This makes it possible to reduce the thickness of the display panel P1.

In the edge-light type display device 1A, there is a possibility that light will pass through the planarization layer 60 multiple times. Therefore, it is preferable that the planarization layer 60 is made of a material that absorbs as little light as possible and has small wavelength dispersion. The planarization layer 60 is formed so as to cover the base substrate (for example, the rear cover substrate 51) on which the patterns (for example, the heater lines HL) are formed. The planarization layer 60 is an insulating layer made of, for example, an organic insulating material. The planarization layer 60 has a function to planarize unevenness caused by the patterns formed on the base substrate. In the example illustrated in FIG. 4, the planarization layer 60 is referred to also as an overcoat layer.

As illustrated in FIG. 4, the adhesive layer 81 is provided between the lower surface of the array substrate 10 and the upper surface of the planarization layer 60. The adhesive layer 81 has an upper surface and a lower surface opposite to the upper surface. The upper surface of the adhesive layer 81 is in contact with the lower surface of the array substrate 10. The lower surface 81b of the adhesive layer 81 is in contact with the upper surface of the planarization layer 60. The adhesive layer 81 functions to adhere the array substrate 10 and the planarization layer 60. The planarization layer 60 and the rear cover substrate 51 are fixed to the array substrate 10 by the adhesive layer 81. The adhesive layer 81 has visible light transmittance. The refractive index of the adhesive layer 81 is preferably closer to the refractive index of the planarization layer 60 and the array substrate 10 than to that of air. By setting the refractive index of the adhesive layer 81 to be equal to that of the planarization layer 60 and the array substrate 10, reflection of the light L1 at the interface between the upper surface of the planarization layer 60 or the lower surface of the array substrate 10 and the adhesive layer 81 can be suppressed. Examples of the adhesive layer 81 include a transparent adhesive sheet referred to as an OCA (Optical Clear Adhesive) formed into sheet-like shape and an OCR (Optical Clear Resin) used by curing a liquid transparent adhesive.

As illustrated in FIG. 4, the front cover substrate 52 has an upper surface and a lower surface opposite to the upper surface. The upper surface and the lower surface are spaced apart from each other. Also, the front cover substrate 52 further has the side surface 52c (see FIG. 3) provided between the upper surface and the lower surface. In the example illustrated in FIG. 4, the side surface 52c of the front cover substrate 52 functions as a light incident surface for introducing light into the front cover substrate 52. The front cover substrate 52 functions as a light guide plate. The side surface 52c of the front cover substrate 52 faces the light source unit 30. In this embodiment, when the display panel P1 is seen in plan view, the light emitted from the light source unit 30 travels in the Y direction illustrated in FIG. 4.

In this embodiment, the front cover substrate 52 is made of glass. In other words, the front cover substrate 52 is a glass substrate made of glass. The front cover substrate 52 has visible light transmittance. Examples of the material of the front cover substrate 52 include organic materials such as acrylic resin and polycarbonate resin in addition to glass.

As illustrated in FIG. 4, the adhesive layer 82 is provided between the lower surface of the front cover substrate 52 and the upper surface of the counter substrate 20. The adhesive layer 82 has an upper surface and a lower surface opposite to the upper surface. The upper surface of the adhesive layer 82 is in contact with the lower surface of the front cover substrate 52. The lower surface of the adhesive layer 82 is in contact with the upper surface of the counter substrate 20. The adhesive layer 82 functions to adhere the front cover substrate 52 and the counter substrate 20. The front cover substrate 52 is fixed to the counter substrate 20 by the adhesive layer 82. The adhesive layer 82 has visible light transmittance. The refractive index of the adhesive layer 82 is preferably closer to the refractive index of the front cover substrate 52 and the counter substrate 20 than to that of air. By setting the refractive index of the adhesive layer 82 to be equal to that of the front cover substrate 52 and the counter substrate 20, reflection of the light L1 at the interface between the lower surface of the front cover substrate 52 or the upper surface of the counter substrate 20 and the adhesive layer 82 can be suppressed. Examples of the adhesive layer 82 include a transparent adhesive sheet referred to as an OCA (Optical Clear Adhesive) formed into sheet-like shape and an OCR (Optical Clear Resin) used by curing a liquid transparent adhesive. Hereinafter, the adhesive layer 81 and the adhesive layer 82 may be collectively referred to as the adhesive layer 80.

Next, how the display panel P1 appears when an observer 100A illustrated in FIG. 4 views the display panel P1 from above will be described with reference to FIG. 5. When viewed from above, if the positional relationship between the observer and the objects changes, the positional relationship between the objects also changes. That is, how the objects appear also changes. On the other hand, when viewed in plan view, even if the positional relationship between the observer and the objects changes, the positional relationship between the objects does not change. As illustrated in FIG. 5, the source line SL is blocked by the light blocking material BM, so the source line SL is not directly viewed from the observer 100A illustrated in FIG. 4. Of the three heater lines HL illustrated in FIG. 4, the heater line HL at the center is blocked by the light blocking material BM, so it is not directly viewed from the observer 100A illustrated in FIG. 4. The two heater lines HL adjacent to the heater line HL at the center can be directly viewed from the observer 100A illustrated in FIG. 4.

Next, the effect of the display device 1A according to this embodiment will be described. In the transparent display, in general, the field sequential driving using LEDs of three colors RGB is adopted for color image display. The rising response speed of the liquid crystal LQ decreases as the ambient temperature becomes lower. This causes the display luminance to start to decrease. In addition, the falling response speed of the liquid crystal LQ also decreases as the ambient temperature becomes lower. This causes the lighting to continue even during the LED lighting period of the next frame color. As a result, color mixing may occur, and the displayed image may shift toward monochrome as the temperature becomes lower.

One conceivable countermeasure against the luminance decrease and the shift toward monochrome is to improve the response speed of the liquid crystal LQ. In order to improve the response speed of the liquid crystal LQ, heat needs to be applied to the liquid crystal LQ. Examples of the heating method include a resistance hearting method in which the heater line HL made of metal is formed on a glass substrate and heat is generated by passing a current through it. Objects for forming the heater line HL are assumed to be the front cover substrate 52, the rear cover substrate 51, the counter substrate 20, the array substrate 10, and others in the display device 1A, but if the metal line overlaps with the aperture of a pixel, it may cause the luminance decrease due to the reduction in aperture ratio and the occurrence of moire. Therefore, it is desirable that the heater line HL is laid out so as to be hidden behind the source line SL, the gate line GL, the light blocking material BM, and others of the pixel. Further, since there is a possibility that the scattered light generated by irradiating the heater line HL with the LED light entering from the side surface of the glass increases the black luminance to decrease contrast, arrangement to reduce the scattered light as much as possible is necessary.

The display device 1A according to this embodiment has the heater line HL. This can improve the response speed of the liquid crystal LQ. Consequently, it is possible to prevent the brightness of the display device 1A from decreasing. Also, it is possible to prevent the falling speed from decreasing. As a result, when the display device 1A is used in a low-temperature environment, it is possible to prevent the image display from becoming monochrome. In the display device 1A according to this embodiment, when the display panel P1 is seen in plan view, the heater line HL is provided so as to overlap with the position of the source line SL and extend along the source line SL. This can prevent the generation of scattered light even when the heater line HL is provided. As a result, even when the heater line HL is provided, it is possible to prevent the black luminance from increasing and the contrast from decreasing.

Furthermore, in the display device 1A according to this embodiment, the heater line HL is provided on the upper surface 51a of the rear cover substrate 51. This can improve the degree of freedom in the pattern layout of the heater line HL. Furthermore, since the upper surface 51a of the rear cover substrate 51 on which the heater line HL is arranged is spaced apart from the light incident surface of the front cover substrate 52, the generation of scattered light can be suppressed.

In addition, the heater line HL can be provided along the gate line GL. For example, when the display panel P1 is seen in plan view, the heater line HL overlaps with the position where the gate line GL is arranged. When the display panel P1 is seen in plan view, it is preferable that the width of the heater line HL is smaller than the width of the gate line GL. When the display panel P1 is seen in plan view, the heater line HL provided along the gate line GL intersects with the heater line HL provided along the source line SL. The heater line HL provided along the gate line GL is in electrical contact with the heater line HL provided along the source line SL. In other words, the heater line HL is provided in a mesh pattern. This makes it possible to prevent the decrease in the heater function due to the breakage of the heater line HL.

When the display panel P1 is seen in plan view, it is preferable that the width of the heater line HL is smaller than the width of the source line SL. When the display panel P1 is seen in plan view, it is preferable that the position of the heater line HL is located inside the region in which the source line SL is arranged. This can further reduce the generation of scattered light. The heater line HL is provided along the light blocking material BM. When the display panel P1 is seen in plan view, the position of the heater line HL overlaps with the position of the light blocking material BM. When the display panel P1 is seen in plan view, it is preferable that the width of the heater line HL is smaller than the width of the light blocking material BM. When the display panel P1 is seen in plan view, it is preferable that the position of the heater line HL is located inside the region in which the light blocking material BM is arranged. This can further reduce the generation of scattered light.

### <Configuration Example of Circuit>

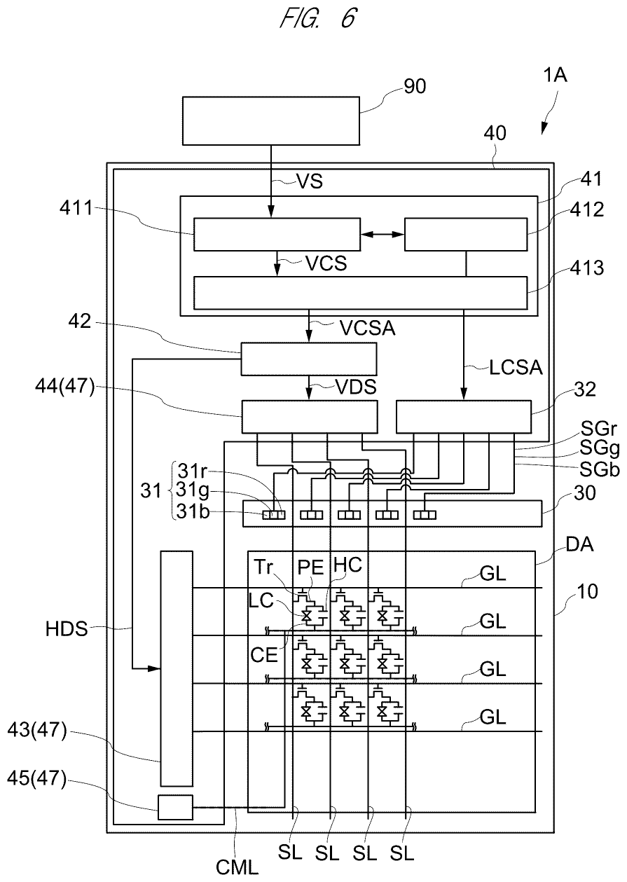

Next, the configuration example of the circuit provided in the display device 1A illustrated in FIG. 4 will be described. FIG. 6 is a circuit block diagram illustrating an example of a circuit provided in the display device illustrated in FIG. 4. The wiring path connected to a common electrode CE illustrated in FIG. 6 is formed on, for example, the counter substrate 20 illustrated in FIG. 4. In the example illustrated in FIG. 6, a light source control unit 32 is included in the drive circuit 40. As a modification, the light source control unit 32 may be provided separately from the drive circuit 40. The light source control unit 32 is formed on, for example, a wiring board (not illustrated) connected to the light source unit 30 illustrated in FIG. 3, and is electrically connected to the light source 31 via the wiring board.

In the example illustrated in FIG. 6, the drive circuit 40 includes a signal processing circuit 41, a pixel control circuit 42, and a display panel drive circuit 47. The display panel drive circuit 47 includes a gate drive circuit 43, a source drive circuit 44, and a common potential drive circuit 45. Also, the light source 31 includes, for example, a red light source portion 31r, a green light source portion 31g, and a blue light source portion 31b. By making the area of the array substrate 10 larger than the area of the counter substrate 20, the drive circuit 40 and the light source unit 30 can be provided on the array substrate 10.

The signal processing circuit 41 includes an input signal analysis unit (input signal analysis circuit) 411, a memory unit (memory circuit) 412, and a signal adjustment unit 413. The display panel P1 includes a control unit 90 in which a control circuit for controlling the display of an image is provided, and an input signal VS is input to the input signal analysis unit 411 of the signal processing circuit 41 from the control unit 90 via a wiring path such as a flexible wiring board (not illustrated). The input signal analysis unit 411 performs an analysis process based on the input signal VS input from the outside, and generates an input signal VCS. The input signal VCS is, for example, a signal that determines what gradation value is to be given to each pixel PIX (see FIG. 3) of the display panel P1 (see FIG. 3) based on the input signal VS.

The signal adjustment unit 413 generates an input signal VCSA from the input signal VCS input from the input signal analysis unit 411. The signal adjustment unit 413 sends the input signal VCSA to the pixel control circuit 42, and sends a light source control signal LCSA to the light source control unit 32. The light source control signal LCSA is, for example, a signal that includes information of the amount of light of the light source 31 that is set according to the input gradation value to the pixel PIX. For example, when a dark image is to be displayed, the amount of light of the light source 31 is set to be small. When a bright image is to be displayed, the amount of light of the light source 31 is set to be large.

The pixel control circuit 42 generates a horizontal drive signal HDS and a vertical drive signal VDS based on the input signal VCSA. For example, in this embodiment, since the field sequential method is adopted for driving, the horizontal drive signal HDS and the vertical drive signal VDS are generated for each light color that the light source 31 can emit. The gate drive circuit 43 sequentially selects the gate lines GL of the display panel P1 (see FIG. 3) within one vertical scanning period based on the horizontal drive signal HDS. The order of selection of the gate lines GL is arbitrary. As illustrated in FIG. 3, the plurality of gate lines (signal lines) GL extends in the X direction and is arranged along the Y direction.

The source drive circuit 44 supplies a gradation signal according to the output gradation value of each pixel PIX (see FIG. 3) to each source line SL of the display panel P1 (see FIG. 3) within one horizontal scanning period based on the vertical drive signal VDS. As illustrated in FIG. 3, the plurality of source lines (signal lines) SL extends in the Y direction and is arranged along the X direction. One pixel PIX is formed at each intersection of the gate line GL and the source line SL. The switching element Tr is formed at each portion where the gate line GL and the source line SL intersect. The plurality of gate lines GL and the plurality of source lines SL correspond to a plurality of signal lines that transmits drive signals to drive the liquid crystal LQ.

For example, a thin film transistor is used as the switching element Tr illustrated in FIG. 6. The type of thin film transistor is not particularly limited, and examples thereof include the following. When classified based on the position of the gate, examples include bottom gate transistors or top gate transistors. Also, when classified based on the number of gates, examples include single gate thin film transistors and double gate thin film transistors. One of the source electrode and drain electrode of the switching element Tr is connected to the source line SL, the gate electrode thereof is connected to the gate line GL, and the other of the source electrode and drain electrode thereof is connected to one end of a capacitance of polymer-dispersed liquid crystal LC. One end of the capacitance of the polymer-dispersed liquid crystal LC is connected to the switching element Tr via a pixel electrode PE, and the other end thereof is connected to a common potential line CML via the common electrode CE. Further, a holding capacitance HC is generated between the pixel electrode PE and a holding capacitance electrode electrically connected to the common potential line CML. Note that the common potential drive circuit 45 supplies potential to the common potential line CML.

### <Light Source Unit>

The configuration of the light source unit 30 will be described. The light source unit 30 is provided at a position facing the side surface 52c of the front cover substrate 52. Though not particularly limited, the light source unit 30 includes, for example, the light source 31 and a lens. The light source 31 includes, for example, the red light source portion 31r, the green light source portion 31g, and the blue light source portion 31b. The red light source portion 31r, the green light source portion 31g, and the blue light source portion 31b are made up of, for example, a plurality of light emitting diode elements. The lens is arranged between, for example, the side surface 52c of the front cover substrate 52 illustrated in FIG. 4 and the plurality of light emitting diode elements. The plurality of light emitting diode elements includes, for example, a light emitting diode element capable of emitting light of a first color (for example, red), a light emitting diode element capable of emitting light of a second color (for example, green) different from the first color, and a light emitting diode element capable of emitting light of a third color (for example, blue) different from the first color and the second color. The plurality of light emitting diode elements is arranged in the X direction along the side surface 52c of the front cover substrate 52.

In the case of the display device 1A configured to perform color display, for example, lighting and non-lighting of the light source 31 are controlled. Also, each of the red light source portion 31r, the green light source portion 31g, and the blue light source portion 31b is lit at different timings. Specifically, the light source control unit 32 illustrated in FIG. 6 outputs a signal SGr for controlling the lighting and non-lighting of the red light source portion 31r to the red light source portion 31r, outputs a signal SGg for controlling the lighting and non-lighting of the green light source portion 31g to the green light source portion 31g, and outputs a signal SGb for controlling the lighting and non-lighting of the blue light source portion 31b to the blue light source portion 31b.

When adjusting the white balance of the display device 1A, the luminance of the light emitting diode elements of respective colors is adjusted based on the chromaticity of each single color of the RGB colors. Specifically, in the adjustment of white balance, the currents and lighting durations input to each of the red light source portion 31r, the green light source portion 31g, and the blue light source portion 31b are adjusted so as to reduce variations in the luminance among the RGB colors. In the above, an example in which the light source unit 30 is provided at the position facing the side surface 52c of the front cover substrate 52 has been described. However, the arrangement of the light source unit 30 is not particularly limited, and it may be provided at a position facing the side surface of the rear cover substrate 51 or a position facing the side surface of the counter substrate 20.

### <Modification>

Modifications of the display device according to this embodiment will be described. Note that the same components may be denoted by the same reference characters and the description thereof may be omitted in some cases.

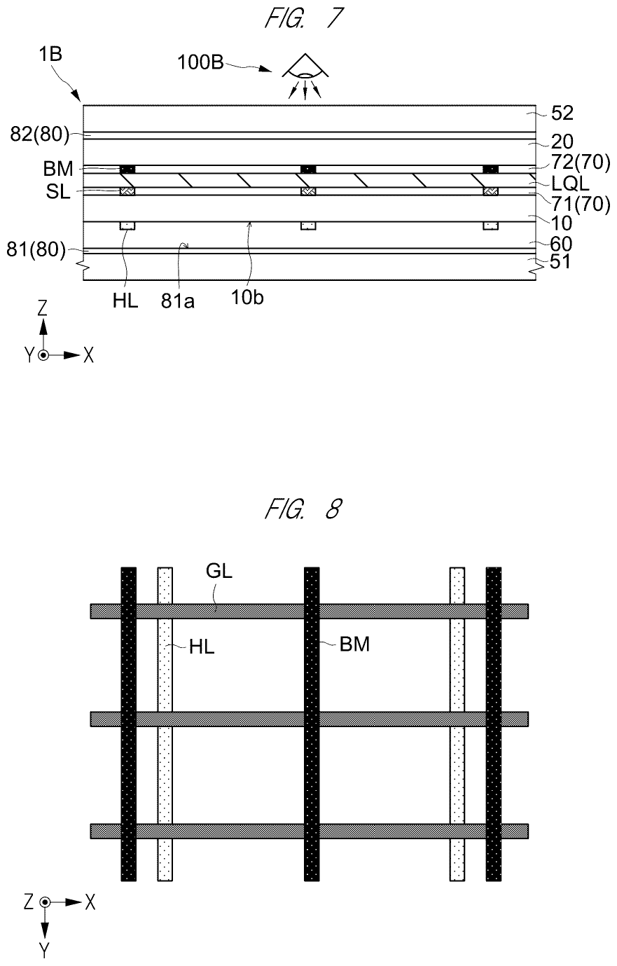

FIG. 7 is a cross-sectional view of a display device according to another embodiment. FIG. 8 is an overhead view of the display device illustrated in FIG. 7.

A display device 1B illustrated in FIG. 7 is different from the display device 1A illustrated in FIG. 4 in that the heater line HL is provided on the lower surface 10b of the array substrate 10. The heater line HL is in contact with the lower surface 10b of the array substrate 10. Also, as illustrated in FIG. 7, the planarization layer 60 is provided on the lower surface 10b of the array substrate 10. The upper surface of the planarization layer 60 is in contact with the lower surface 10b of the array substrate 10. The planarization layer 60 is provided so as to cover the heater line HL. The lower surface of the planarization layer 60 is spaced apart from the heater line HL. The adhesive layer 81 is provided between the planarization layer 60 and the rear cover substrate 51. The upper surface 81a of the adhesive layer 81 is in contact with the lower surface of the planarization layer 60. The lower surface of the adhesive layer 81 is in contact with the upper surface of the rear cover substrate 51.

Next, how the display panel P1 appears when an observer 100B illustrated in FIG. 7 views the display panel P1 from above will be described with reference to FIG. 8. As illustrated in FIG. 8, the source line SL is blocked by the light blocking material BM, so the source line SL is not directly viewed from the observer 100B illustrated in FIG. 7. Of the three heater lines HL illustrated in FIG. 7, the heater line HL at the center is blocked by the light blocking material BM, so it is not directly viewed from the observer 100B illustrated in FIG. 7. The two heater lines HL adjacent to the heater line HL at the center can be directly viewed from the observer 100B illustrated in FIG. 7.

According to the display device 1B illustrated in FIG. 7, the heater line HL is provided on the lower surface 10b of the array substrate 10, and it is thus possible to improve the degree of freedom in the pattern layout of the heater line HL. Furthermore, since the lower surface 10b of the array substrate 10 on which the heater line HL is arranged is spaced apart from the light incident surface of the front cover substrate 52, the generation of scattered light can be suppressed. In addition, since the planarization layer 60 can protect the heater line HL, it is possible to omit the rear cover substrate 51 and the adhesive layer 81.

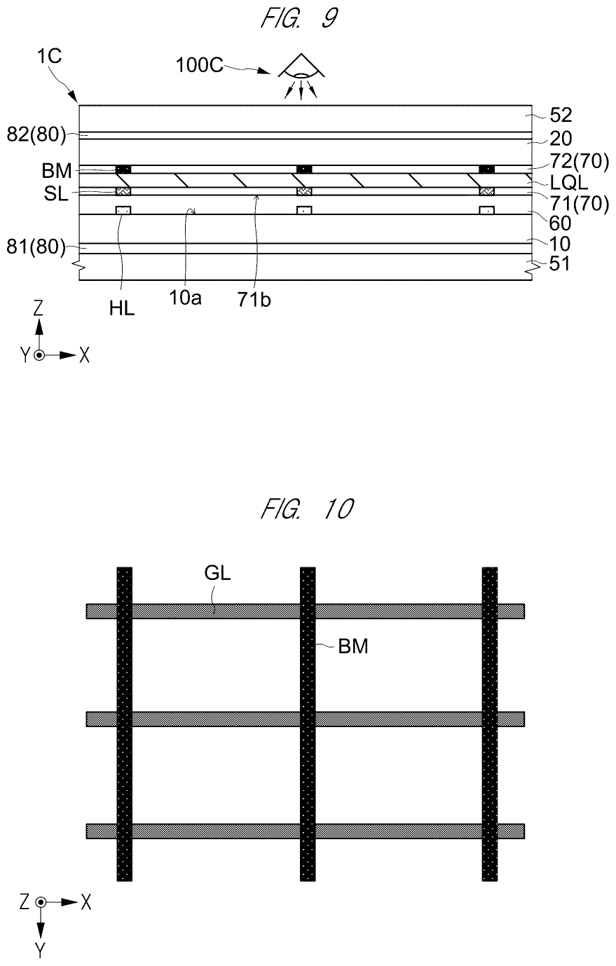

FIG. 9 is a cross-sectional view of a display device according to another embodiment. FIG. 10 is an overhead view of the display device illustrated in FIG. 9. A display device 1C illustrated in FIG. 9 is different from the display device 1A illustrated in FIG. 4 in that the heater line HL is provided on the upper surface 10a of the array substrate 10. The heater line HL is in contact with the upper surface 10a of the array substrate 10. The planarization layer 60 is provided on the upper surface 10a of the array substrate 10. The planarization layer 60 is provided between the array substrate 10 and the alignment film 71. The lower surface of the planarization layer 60 is in contact with the upper surface 10a of the array substrate 10. The upper surface of the planarization layer 60 is spaced apart from the heater line HL. The upper surface of the planarization layer 60 is in contact with the lower surface 71b of the alignment film 71. The source line SL is provided on the upper surface of the planarization layer 60. The adhesive layer 81 is provided between the array substrate 10 and the rear cover substrate 51. The upper surface of the adhesive layer 81 is in contact with the lower surface of the array substrate 10. The lower surface of the adhesive layer 81 is in contact with the upper surface of the rear cover substrate 51.

The display device 1C illustrated in FIG. 9 can be manufactured by, for example, forming the heater line HL on the TFT circuit side of the array substrate 10, providing the planarization layer 60 for planarization, and then forming the TFT circuit.

Next, how the display panel P1 appears when an observer 100C illustrated in FIG. 9 views the display panel P1 from above will be described with reference to FIG. 10. As illustrated in FIG. 10, the source line SL is blocked by the light blocking material BM, so the source line SL is not directly viewed from the observer 100C illustrated in FIG. 9. The heater line HL is also blocked by the light blocking material BM, so the heater line HL is not directly viewed from the observer 100C illustrated in FIG. 9.

According to the display device 1C illustrated in FIG. 9, the heater line HL can be formed in the film-forming process of the array substrate 10, so the alignment accuracy between the heater line HL and the source line SL and others can be improved. In addition, since the heater line HL is close to the source line SL and the light blocking material BM in the display device 1C, the occurrence of moire due to the viewing angle can be suppressed. Also, since the light entering the heater line HL is blocked by the light blocking material BM or the source line SL, the generation of scattered light can be suppressed.

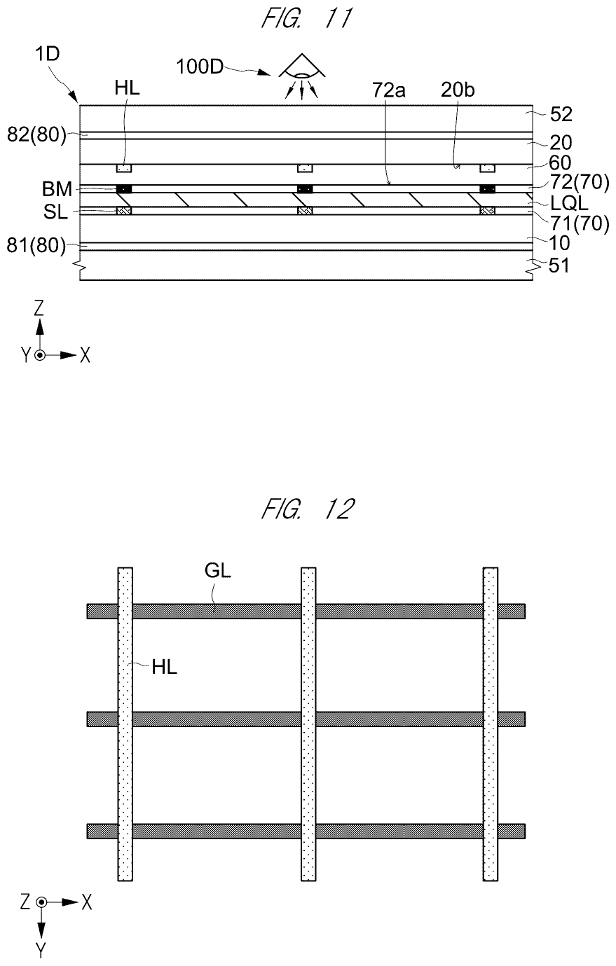

FIG. 11 is a cross-sectional view of a display device according to another embodiment. FIG. 12 is an overhead view of the display device illustrated in FIG. 11. A display device 1D illustrated in FIG. 11 is different from the display device 1A illustrated in FIG. 4 in that the heater line HL is provided on the lower surface 20b of the counter substrate 20. The heater line HL is in contact with the lower surface 20b of the counter substrate 20. The planarization layer 60 is provided on the lower surface 20b of the counter substrate 20. The planarization layer 60 is provided between the counter substrate 20 and the alignment film 72. The upper surface of the planarization layer 60 is in contact with the lower surface 20b of the counter substrate 20. The lower surface of the planarization layer 60 is spaced apart from the heater line HL. The lower surface of the planarization layer 60 is in contact with the upper surface 72a of the alignment film 72. The light blocking material BM is provided on the lower surface of the planarization layer 60. The light blocking material BM is in contact with the lower surface of the planarization layer 60.

The display device 1D illustrated in FIG. 11 can be manufactured by, for example, forming the heater line HL on the light blocking material BM side of the counter substrate 20, providing the planarization layer 60 for planarization, and then forming the light blocking material BM.

Next, how the display panel P1 appears when an observer 100D illustrated in FIG. 11 views the display panel P1 from above will be described with reference to FIG. 12. As illustrated in FIG. 12, the source line SL is blocked by the heater line HL and the light blocking material BM, so the source line SL is not directly viewed from the observer 100D illustrated in FIG. 11. The light blocking material BM is also blocked by the heater line HL, so the light blocking material BM is not directly viewed from the observer 100D illustrated in FIG. 11.

According to the display device 1D illustrated in FIG. 11, the heater line HL can be formed in the film-forming process of the counter substrate 20, so the alignment accuracy between the heater line HL and the light blocking material BM can be improved. In addition, since the heater line HL is close to the source line SL and the light blocking material BM in the display device 1D, the occurrence of moire due to the viewing angle can be suppressed. In addition, since the heater line HL is electrically insulated from the light blocking material BM by the planarization layer 60, a voltage can be applied to the heater line HL at all times.

In the display device 1D illustrated in FIG. 11, the light blocking material BM may be used also as the heater line HL. In other words, the light blocking material BM can function also as a heater. This eliminates the need to provide the heater line HL separately from the light blocking material BM. When the light blocking material BM is used also as the heater line HL, the light blocking material BM is controlled such that the period in which the light blocking material BM is used as the common potential line CML and the period in which the light blocking material BM is used as a heater are temporally separated.

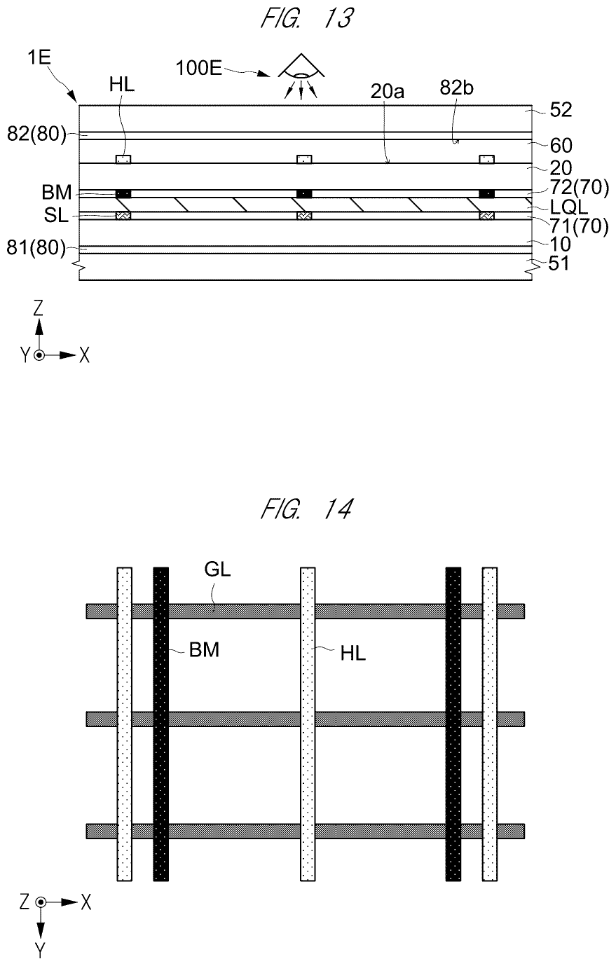

FIG. 13 is a cross-sectional view of a display device according to another embodiment. FIG. 14 is an overhead view of the display device illustrated in FIG. 13. A display device 1E illustrated in FIG. 13 is different from the display device 1A illustrated in FIG. 4 in that the heater line HL is provided on the upper surface 20a of the counter substrate 20. The heater line HL is in contact with the upper surface 20a of the counter substrate 20. The planarization layer 60 is provided on the upper surface 20a of the counter substrate 20. The lower surface of the planarization layer 60 is in contact with the upper surface 20a of the counter substrate 20. The planarization layer 60 is provided between the adhesive layer 82 and the counter substrate 20. The upper surface of the planarization layer 60 is spaced apart from the heater line HL. The upper surface of the planarization layer 60 is in contact with the lower surface 82b of the adhesive layer 82.

Next, how the display panel P1 appears when an observer 100E illustrated in FIG. 13 views the display panel P1 from above will be described with reference to FIG. 14. As illustrated in FIG. 14, the source line SL is blocked by the light blocking material BM, so the source line SL is not directly viewed from the observer 100E illustrated in FIG. 13. Of the three light blocking materials BM illustrated in FIG. 13, the light blocking material BM at the center is blocked by the heater line HL, so it is not directly viewed from the observer 100E illustrated in FIG. 13. The two light blocking materials BM adjacent to the light blocking material BM at the center can be directly viewed from the observer 100E illustrated in FIG. 13.

According to the display device 1E illustrated in FIG. 13, the heater line HL is provided on the upper surface 20a of the counter substrate 20, and it is thus possible to improve the degree of freedom in the pattern layout of the heater line HL.

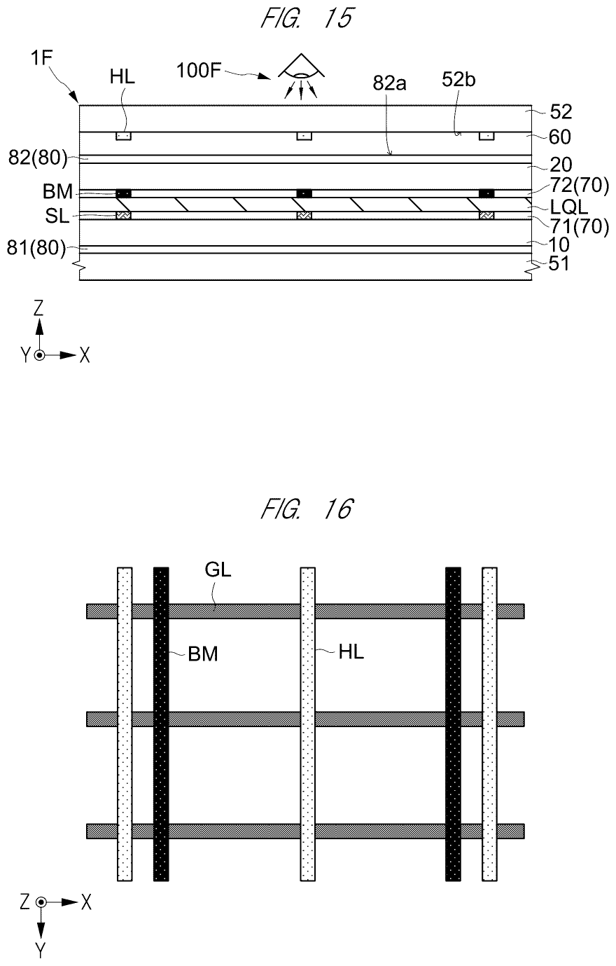

FIG. 15 is a cross-sectional view of a display device according to another embodiment. FIG. 16 is an overhead view of the display device illustrated in FIG. 15. A display device 1F illustrated in FIG. 15 is different from the display device 1A illustrated in FIG. 4 in that the heater line HL is provided on the lower surface 52b of the front cover substrate 52. The heater line HL is in contact with the lower surface 52b of the front cover substrate 52. The planarization layer 60 is provided on the lower surface 52b of the front cover substrate 52. The upper surface of the planarization layer 60 is in contact with the lower surface 52b of the front cover substrate 52. The lower surface of the planarization layer 60 is spaced apart from the heater line HL. The planarization layer 60 is provided between the front cover substrate 52 and the adhesive layer 82. The lower surface of the planarization layer 60 is in contact with the upper surface 82a of the adhesive layer 82.

Next, how the display panel P1 appears when an observer 100F illustrated in FIG. 15 views the display panel P1 from above will be described with reference to FIG. 16. As illustrated in FIG. 16, the source line SL is blocked by the light blocking material BM, so the source line SL is not directly viewed from the observer 100F illustrated in FIG. 15. Of the three light blocking materials BM illustrated in FIG. 15, the light blocking material BM at the center is blocked by the heater line HL, so it is not directly viewed from the observer 100F illustrated in FIG. 15. The two light blocking materials BM adjacent to the light blocking material BM at the center can be directly viewed from the observer 100F illustrated in FIG. 15.

According to the display device 1F illustrated in FIG. 15, the heater line HL is provided on the lower surface 52b of the front cover substrate 52. This can improve the degree of freedom in the pattern layout of the heater line HL.

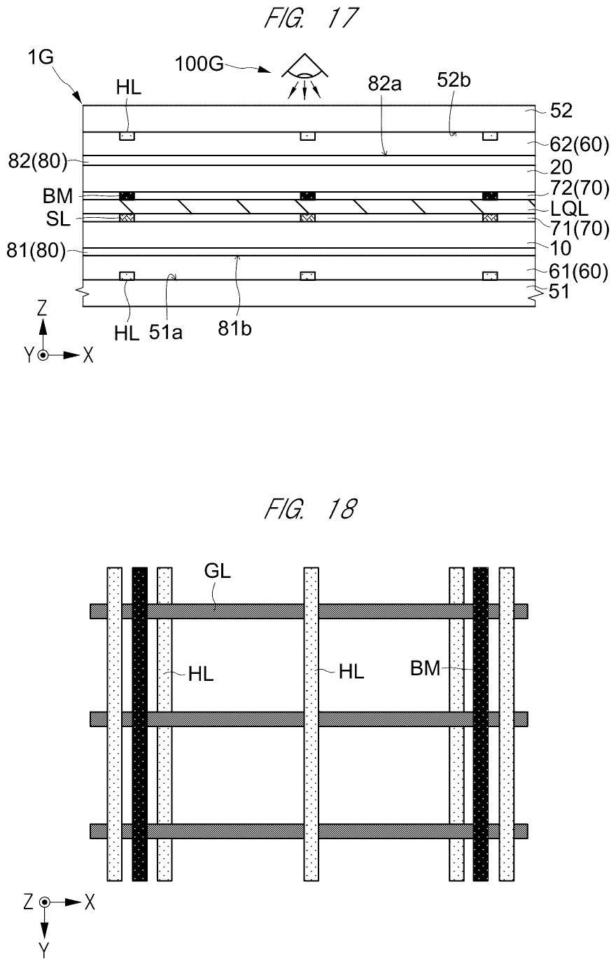

FIG. 17 is a cross-sectional view of a display device according to another embodiment. FIG. 18 is an overhead view of the display device illustrated in FIG. 17. A display device 1G illustrated in FIG. 17 is different from the display device 1A illustrated in FIG. 4 in that the heater line HL is provided on the upper surface 51a of the rear cover substrate 51 and on the lower surface 52b of the front cover substrate 52. The heater line HL is in contact with the lower surface 52b of the front cover substrate 52. The display device 1G illustrated in FIG. 17 includes a plurality of the planarization layers 60. The plurality of planarization layers 60 includes a planarization layer 61 and a planarization layer 62. The planarization layer 62 is provided on the lower surface 52b of the front cover substrate 52. An upper surface of the planarization layer 62 is in contact with the lower surface 52b of the front cover substrate 52. A lower surface of the planarization layer 62 is spaced apart from the heater line HL. The planarization layer 62 is provided between the front cover substrate 52 and the adhesive layer 82. The lower surface of the planarization layer 62 is in contact with the upper surface 82a of the adhesive layer 82. The planarization layer 61 is arranged in the same manner as the planarization layer 60 of the display device 1A illustrated in FIG. 4.

Next, how the display panel P1 appears when an observer 100G illustrated in FIG. 17 views the display panel P1 from above will be described with reference to FIG. 18. As illustrated in FIG. 18, the source line SL is blocked by the light blocking material BM, so the source line SL is not directly viewed from the observer 100G illustrated in FIG. 17. Of the three heater lines HL provided on the upper surface 51a of the rear cover substrate 51 illustrated in FIG. 17, the heater line HL at the center is blocked by the light blocking material BM, so it is not directly viewed from the observer 100G illustrated in FIG. 17. The two heater lines HL adjacent to the heater line HL at the center and provided on the upper surface of the rear cover substrate 51 can be directly viewed from the observer 100G illustrated in FIG. 17. Also, of the three light blocking materials BM illustrated in FIG. 17, the light blocking material BM at the center is blocked by the heater line HL provided on the lower surface 52b of the front cover substrate 52, so it is not directly viewed from the observer 100G illustrated in FIG. 17. The two light blocking materials BM adjacent to the light blocking material BM at the center can be directly viewed from the observer 100G illustrated in FIG. 17.

According to the display device 1G illustrated in FIG. 17, the heater line HL is provided on both the lower surface 52b of the front cover substrate 52 and the upper surface 51a of the rear cover substrate 51, and it is thus possible to improve the heating performance of the heater lines HL.

A person having ordinary skill in the art can conceive of various alterations and corrections within a range of the idea of the present invention, and the alterations and corrections are interpreted to belong to the scope of the present invention. For example, the embodiment obtained by performing addition or elimination of components or design change or the embodiment obtained by performing addition or reduction of process or condition change to each embodiment described above by a person having an ordinary skill in the art is also included in the scope of the present invention as long as it includes the gist of the present invention. Furthermore, other effects and advantages brought about by the aspects described in the above embodiments that are obvious from the description in this specification or that could be appropriately thought of by a person having ordinary skill in the art are naturally interpreted as being brought about by the present invention.

What is claimed is:

1. A display device comprising:
a heater line containing metal;
a first substrate including at least one first line;
a second substrate facing the first substrate; and
a liquid crystal layer provided between the first substrate and the second substrate,
wherein the heater line is provided so as to overlap with a position of the first line and extend along the first line in plan view.

2. The display device according to claim 1, further comprising:
a third substrate provided on an opposite side of the second substrate relative to the first substrate; and
a light source provided at a position facing a side surface of the second substrate and capable of emitting light in a first direction in plan view,
wherein the first line is provided along the first direction in plan view, and
wherein the heater line is provided on a surface of the third substrate facing the first substrate.

3. The display device according to claim 1, further comprising:
a fourth substrate provided on an opposite side of the first substrate relative to the second substrate; and
a light source provided at a position facing a side surface of the fourth substrate and capable of emitting light in a first direction in plan view,
wherein the heater line is provided on a surface of the fourth substrate facing the second substrate.

4. The display device according to claim 1, further comprising:
a third substrate provided on an opposite side of the second substrate relative to the first substrate;
a fourth substrate provided on an opposite side of the first substrate relative to the second substrate; and
a light source provided at a position facing a side surface of the fourth substrate and capable of emitting light in a first direction in plan view,
wherein the heater line is provided on a surface of the third substrate facing the first substrate and on a surface of the fourth substrate facing the second substrate.

5. The display device according to claim 1, further comprising:
a light source provided at a position facing a side surface of the second substrate and capable of emitting light in a first direction in plan view,
wherein the heater line is provided on a surface of the first substrate opposite to a surface of the first substrate facing the second substrate.

6. The display device according to claim 1, further comprising:
a light source provided at a position facing a side surface of the second substrate and capable of emitting light in a first direction in plan view,
wherein the heater line is provided on a surface of the first substrate facing the second substrate.

7. The display device according to claim 1, further comprising:
a light source provided at a position facing a side surface of the second substrate and capable of emitting light in a first direction in plan view,
wherein the heater line is provided on a surface of the second substrate facing the first substrate.

8. The display device according to claim 1, further comprising:
a third substrate provided on an opposite side of the second substrate relative to the first substrate; and
a light source provided at a position facing a side surface of the third substrate and capable of emitting light in a first direction in plan view,
wherein the heater line is provided on a surface of the second substrate opposite to a surface of the second substrate facing the first substrate.

9. The display device according to claim 1,
wherein the at least one first line comprises a plurality of first lines, and
wherein, of two of the first lines adjacent to each other, a position of one first line overlaps with a position of the heater line and a position of the other first line does not overlap with the position of the heater line in plan view.

10. The display device according to claim 1,
wherein the first substrate further includes a second line intersecting with the first line.

11. The display device according to claim 1, further comprising:
a light blocking material provided on a surface of the second substrate facing the first substrate,
wherein the light blocking material is arranged along the first line and the heater line so as to overlap with positions of the first line and the heater line in plan view.

12. The display device according to claim 1,
wherein a width of the heater line is smaller than a width of the first line in plan view.

13. The display device according to claim 1,
wherein the heater line is arranged within a region in which the first line is located in plan view.

14. The display device according to claim 1, further comprising a planarization layer provided so as to cover the heater line.

15. The display device according to claim 1,
wherein the first line is provided on a surface of the first substrate facing the second substrate.

16. The display device according to claim 1,
wherein the first line is a source line.

17. The display device according to claim 1, further comprising:
a third substrate provided on an opposite side of the second substrate relative to the first substrate; and
an adhesive layer provided between the first substrate and the third substrate.

18. The display device according to claim 1, further comprising:
a fourth substrate provided on an opposite side of the first substrate relative to the second substrate; and
an adhesive layer provided between the second substrate and the fourth substrate.
